(19) United States
(12) Patent Application Publication
(10) Pub. No.: US 2018/0329876 A1
(43) Pub. Date: Nov. 15, 2018

(54) Smart Templates

(71) Applicant: Microsoft Technology Licensing, LLC, Redmond, WA (US)

(72) Inventors: Eduardo SONNINO, Vancouver (CA); Anthony DART, Redmond, WA (US); Ryan Chandler PENDLAY, Bellevue, WA (US); Jason M. NELSON, Sammamish, WA (US); March ROGERS, Bothell, WA (US); Zachary Adam PFRIEM, Seattle, WA (US); Laurentiu PAVEL, Bellevue, WA (US); Jason HARTMAN, Woodinville, WA (US); Elizabeth Picchietti SALOWITZ, Seattle, WA (US)

(73) Assignee: Microsoft Technology Licensing, LLC, Redmond, WA (US)

(21) Appl. No.: 15/636,164

(22) Filed: Jun. 28, 2017

Related U.S. Application Data
(60) Provisional application No. 62/506,508, filed on May 15, 2017.

(51) Int. Cl. G06F 17/24; H04L 29/08; G06F 3/0482; G06F 3/0483; G06F 3/0488; G06F 17/21; G06F 1/16

(52) U.S. Cl. CPC G06F 17/248; H04L 67/1095; H04L 67/36; G06F 3/0482; G06F 2203/04803; G06F 3/04883; G06F 17/212; G06F 1/1616; G06F 3/0483

(57) ABSTRACT

Techniques for smart templates are described. In one or more implementations, digital content is generated as pages of a journal application. Selectable representations associated with various smart templates are displayed via a user interface of the journal application. Responsive to user selection of one of the selectable representations, a smart page is generated by altering the digital content of an identified page and causing the identified page to inherit one or more rules or functionalities associated with the smart template. Subsequently, free-form user input is received to the smart page, and additional digital content corresponding to the free-form user input is generated on the smart page. The free-form user input is then processed by applying the one or more rules or functionalities to the free-form user input to generate page data.

### RELATED APPLICATION

This application claims priority to U.S. Provisional Application No. 62/506,508, filed May 15, 2017, entitled “Smart Templates”, the disclosure of which is hereby incorporated by reference herein in its entirety.

### BACKGROUND

Increasingly, users are switching from paper-based journals to electronic journals. Additionally, a variety of applications and services have been developed which are enable users to track various different types of information. For example, a calendar application may allow the user to schedule various appointments, while a health application may enable the user to track the user's food intake. However, it is frustrating for users to have to access multiple separate applications in order to track these various different types of information.

### SUMMARY

Techniques for smart templates are described. In one or more implementations, digital content is generated as pages of a journal application. Selectable representations associated with various smart templates are displayed via a user interface of the journal application. Responsive to user selection of one of the selectable representations, a smart page is generated by altering the digital content of an identified page and causing the identified page to inherit one or more rules or functionalities associated with the smart template. Subsequently, free-form user input is received to the smart page, and additional digital content corresponding to the free-form user input is generated on the smart page. The free-form user input is then processed by applying the one or more rules or functionalities to the free-form user input to generate page data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to support techniques for smart templates discussed herein.

FIG. 2 illustrates a system showing the smart page module of FIG. 1 in more detail.

FIGS. 3A-3C illustrate various examples of smart templates in accordance with one or more implementations.

FIG. 4 is a flow diagram that describes steps in a method for applying smart templates to a journal application in accordance with one or more implementations.

FIG. 5 is a flow diagram that describes steps in a method for generating page data based on user input received via a smart page in accordance with one or more implementations.

FIG. 6 illustrates an example system that includes an example computing device that is representative of one or more computing systems and/or devices that may implement the various techniques described herein.

### DETAILED DESCRIPTION

Techniques for smart templates are described. The described techniques may be implemented in a creative environment, such as a journal application, which displays digital content as pages of a journal application. The pages of the journal application are configured to receive free-form user input (e.g., via a stylus) corresponding to writing, drawing, adding pictures or video, and so forth. Generally, the techniques described herein enable the customization of the digital content of the pages of the journal application by applying a smart template to generate a smart page. The smart templates can be designed by developers to include code capable of implementing a variety of different types of rules or functionalities.

In one or more implementations, digital content is generated as pages of a journal application. Selectable representations associated with various smart templates are displayed via a user interface of the journal application. Responsive to user selection of one of the selectable representations, a smart page is generated by altering the digital content of an identified page and causing the identified page to inherit one or more rules or functionalities associated with the smart template. The digital content of the identified page can be altered, for example, by changing a visual layout of the identified page. For instance, a formless page of the journal application can be altered to display words and fields associated with a calendar, a workout log, a nutrition log, a planner, and so forth.

Subsequently, free-form user input is received to the smart page, and additional digital content corresponding to the free-form user input is generated on the smart page. For example, the smart page enables the user to write on the smart page in “free form”, such that any fields included in the smart page do not constrain the user input to a certain area. As such, the user can write on the smart page just as they would write on a paper journal. However, even though the user can write on the smart page in free form, the described techniques process the user input by applying various rules or functionalities associated with the smart page in order to generate page data. In some cases, the user input is processed by applying rules and functionalities of a smart page based at least in part on a position in the smart page at which the user input is received. Alternately, the rules and functionalities may be based on the content of the user input itself without regard to the position at which the user input is received.

In one or more implementations, the smart template is associated with an application that is external to the journal application, such as a calendar application, a health application, a stock trading application, a money management application, and so forth. The application can be located at a computing device at which the journal application is implemented, or remote from the computing device (e.g., a cloud-based service). In these instances, the page data is automatically communicated to the application associated with the smart page for further processing by the application to generate application data based on the page data.

For example, a day planner smart page can be configured to automatically synchronize appointments written on the smart page with a calendar application. As another example, a nutrition smart page can be configured to automatically communicate a food log written on the smart page to a health application that processes the food log to determine the amount of calories and macronutrients the user consumes.

In one or more implementations, the application data can be received from the application, and displayed as additional digital content on the smart page. For example, the day planner smart page can populate the day planner with appointments from the user's calendar, while the nutrition smart page can surface the number of calories consumed proximate the user's food log.

Thus, through the user of smart templates, the described techniques enable the user to quickly customize a page in the journal application with a desired look and feel. Furthermore, the integration with applications or services enables the user to provide free-form user input to a single collection area of the journal, in order to have the user input automatically synchronizes with various applications which can store the data or act on the data in a variety of different ways. As such, the techniques described herein reduce user frustration and constitute an improvement over current approaches which require the user to access a variety of separate applications in order to track different types of information. Furthermore, the described techniques maintain the desirability of using a journal for its free-form input capabilities while giving the user the ability to quickly customize a page in order to provide free form input that can by automatically synchronized with a variety of different applications.

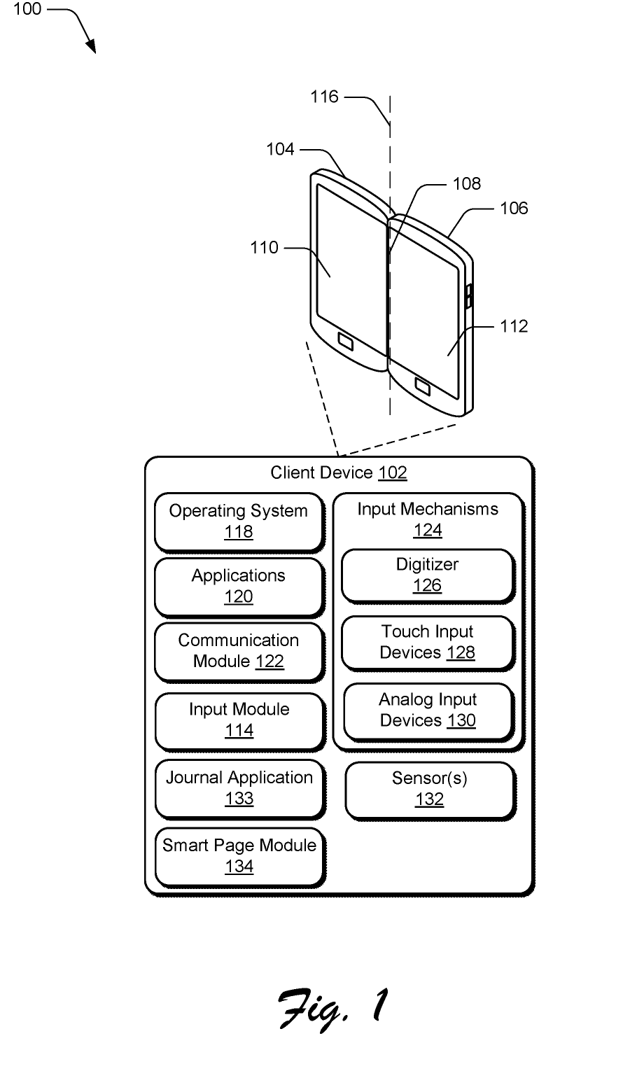

FIG. 1 is an illustration of an environment 100 in an example implementation that is operable to employ techniques for smart templates discussed herein. Environment 100 includes a client device 102 which can be configured for mobile use, such as a mobile phone, a tablet computer, a wearable device, a handheld gaming device, a media player, and so on. In this example, the client device 102 is implemented as a “dual-display” device, and includes a display device 104 and a display device 106 that are connected to one another by a hinge 108. The display device 104 includes a touch surface 110, and the display device 106 includes a touch surface 112. The client device 102 also includes an input module 114 configured to process input received via one of the touch surfaces 110, 112 and/or via the hinge 108. While some of the techniques discussed herein will be described with reference to a dual-display device, it is to be appreciated that in some cases the techniques may also be implemented on a single-screen device, such as a mobile phone, tablet computer, media player, laptop computer, desktop computer, and so forth. In addition, the hinge 108 may allow the display devices 104 and 106 to fold back on each other to provide a “single display” device. As such, the techniques described herein may be designed to function whether the user is operating in a two-display mode or a single-display mode. In addition, while the dual display device is illustrated with a hinge in this example, it is to be appreciated that in some cases the techniques may be implemented in single display, dual-display, or multi-display devices without the hinge.

The hinge 108 is configured to rotationally move about a longitudinal axis 116 of the hinge 108 to allow an angle between the display devices 104, 106 to change. In this way, the hinge 108 allows the display devices 104, 106 to be connected to one another yet be oriented at different angles and/or planar orientations relative to each other. In at least some implementations, the touch surfaces 110, 112 may represent different portions of a single integrated and continuous display surface that can be bent along the hinge 108.

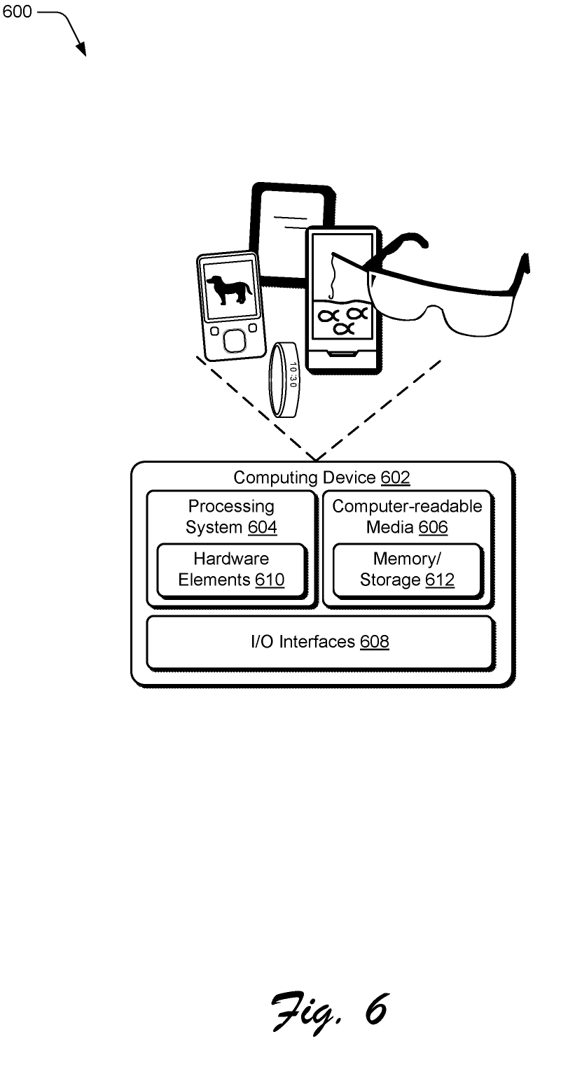

While implementations presented herein are discussed in the context of a mobile device, it is to be appreciated that various other types and form factors of devices may be utilized in accordance with the claimed implementations. Thus, the client device 102 may range from full resource devices with substantial memory and processor resources, to a low-resource device with limited memory and/or processing resources. An example implementation of the client device 102 is discussed below with reference to FIG. 6.

The client device 102 includes a variety of different functionalities that enable various activities and tasks to be performed. For instance, the client device 102 includes an operating system 118, applications 120, and a communication module 122. Generally, the operating system 118 is representative of functionality for abstracting various system components of the client device 102, such as hardware, kernel-level modules and services, and so forth. The operating system 118, for instance, can abstract various components (e.g., hardware, software, and firmware) of the client device 102 to enable interaction between the components and applications running on the client device 102.

The applications 120 are representative of functionality for performing different tasks via the client device 102. In one particular implementation, the applications 120 represent a web browser, web platform, or other application that can be leveraged to browse websites over a network.

The communication module 122 is representative of functionality for enabling the client device 102 to communicate over wired and/or wireless connections. For instance, the communication module 122 represents hardware and logic for communicating data via a variety of different wired and/or wireless technologies and protocols.

According to various implementations, the display devices 104, 106 generally represent functionality for visual output for the client device 102. Additionally, the display devices 104, 106 represent functionality for receiving various types of input, such as touch input, stylus input, touchless proximity input, and so forth via one or more of the touch surfaces 110, 112, which can be used as visual output portions of the display devices 104, 106. The input module 114 is representative of functionality to enable the client device 102 to receive input (e.g., via input mechanisms 124) and to process and route the input in various ways.

The input mechanisms 124 generally represent different functionalities for receiving input to the client device 102, and include a digitizer 126, touch input devices 128, and analog input devices 130. Examples of the input mechanisms 124 include gesture-sensitive sensors and devices (e.g., such as touch-based sensors), a stylus, a touch pad, accelerometers, a microphone with accompanying voice recognition software, and so forth. The input mechanisms 124 may be separate or integral with the display devices 104, 106; integral examples include gesture-sensitive displays with integrated touch-sensitive sensors.

The digitizer 126 represents functionality for converting various types of input to the display devices 104, 106, the touch input devices 128, and the analog input devices 130 into digital data that can be used by the client device 102 in various ways. The analog input devices 130 represent hardware mechanisms (e.g., the hinge 108) that are usable to generate different physical quantities that represent data. For instance, the hinge 108 represents a mechanism that can be leveraged to generate input data by measurement of a physical variable, such as hinge angle of the hinge 108. One or more sensors 132, for example, can measure the hinge angle, and the digitizer 126 can convert such measurements into digital data usable by the client device 102 to display digital content via the display devices 104, 106.

Generally, the sensors 132 represent functionality for detecting different input signals received by the client device 102. For example, the sensors 132 can include one or more hinge sensors configured to detect a hinge angle between the display devices 104, 106. Additionally, the sensors 132 can include grip sensors, such as touch sensors, configured to detect how a user is holding the client device 102. Accordingly, a variety of different sensors 132 can be implemented to detect various different types of digital and/or analog input. These and other aspects are discussed in further detail below.

In one particular implementation, the applications 120 include a journal application 133 which display digital content as pages of a journal. For example, a first page of the journal in a sequence of pages can be displayed on touch surface 110 of display device 104 while a second journal page of the journal in the sequence of pages is displayed on touch surface 112 of display device 106. The user can then write and draw on the pages, as well as insert and/or manipulate various different objects, such as pictures, videos, audio files, and so forth.

In at least some implementations, the journal application 133 includes or otherwise make use of a smart page module 134. The smart page module 134, for example, represents a standalone application. In other implementations, the smart page module 134 is included as part of another application or system software, such as the journal application 133 or the operating system 118. Generally, the smart page module 134 is configured to apply smart templates to pages of the journal application in order to generate smart pages by altering the digital content of an identified page and causing the identified page to inherit one or more rules or functionalities associated with the smart template. In addition, the smart page module 134 monitors user input to the smart page, and generates page data by applying the various rules or functionalities associated with the smart page to the user input. In one or more implementations, smart page module 134 is implemented as code within the smart page 208 itself. In one or more implementations, the smart page module 134 is further configured to interface with an application or service associated with the smart template of a respective smart page in order to transfer data between the smart page and the application or service. Further discussion of this and other features is provided below.

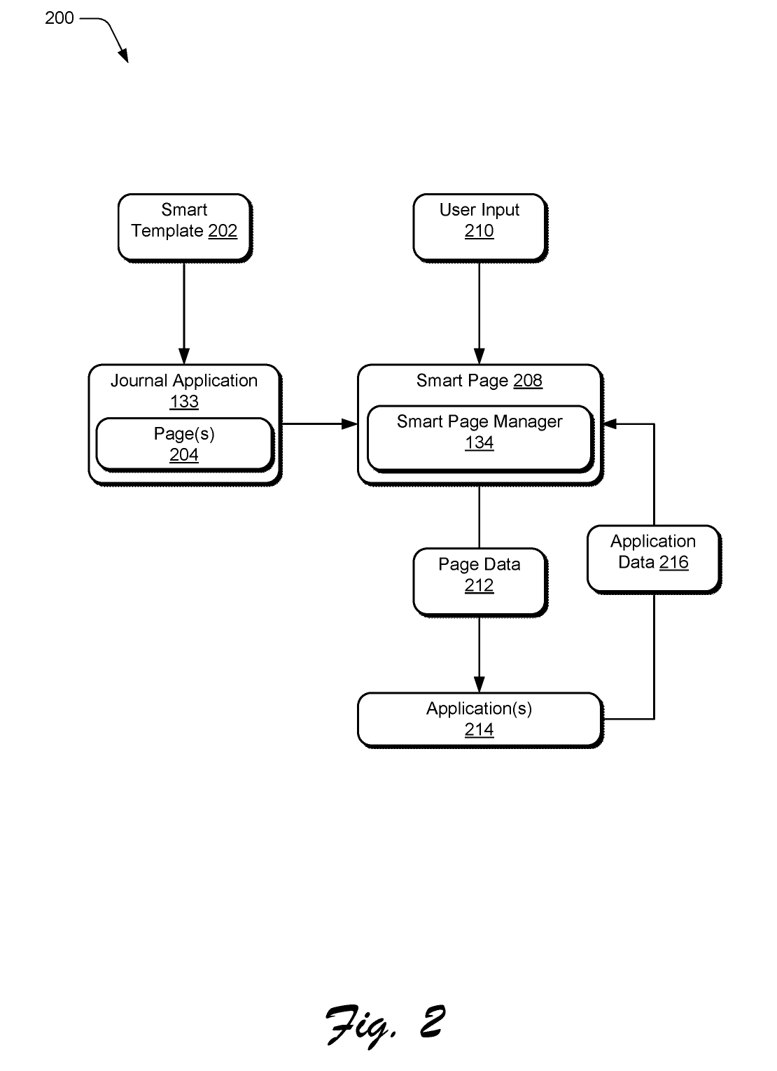

FIG. 2 illustrates a system 200 showing the smart page module 134 in more detail.

In system 200, a smart template 202 is applied to one or more pages 204 of a journal application 133 to generate one or more smart pages 208. Applying the smart template 202 both alters digital content of the one or more pages 204, and causes smart page 208 to inherit one or more rules or functionalities associated with the smart template 202.

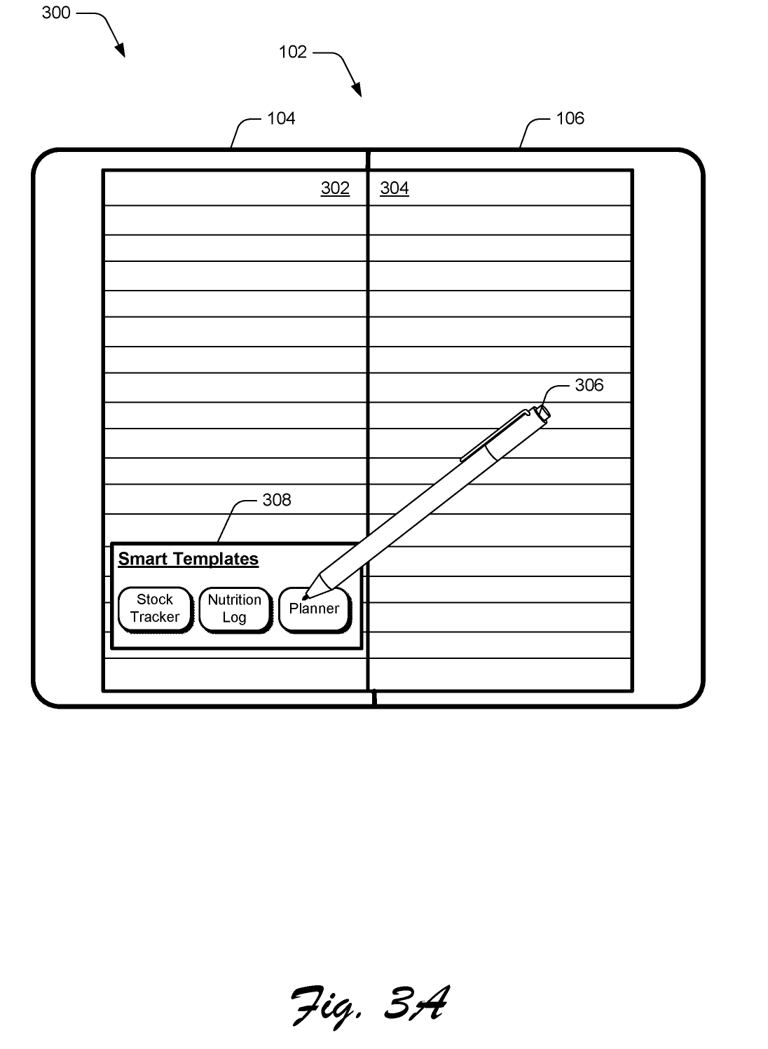

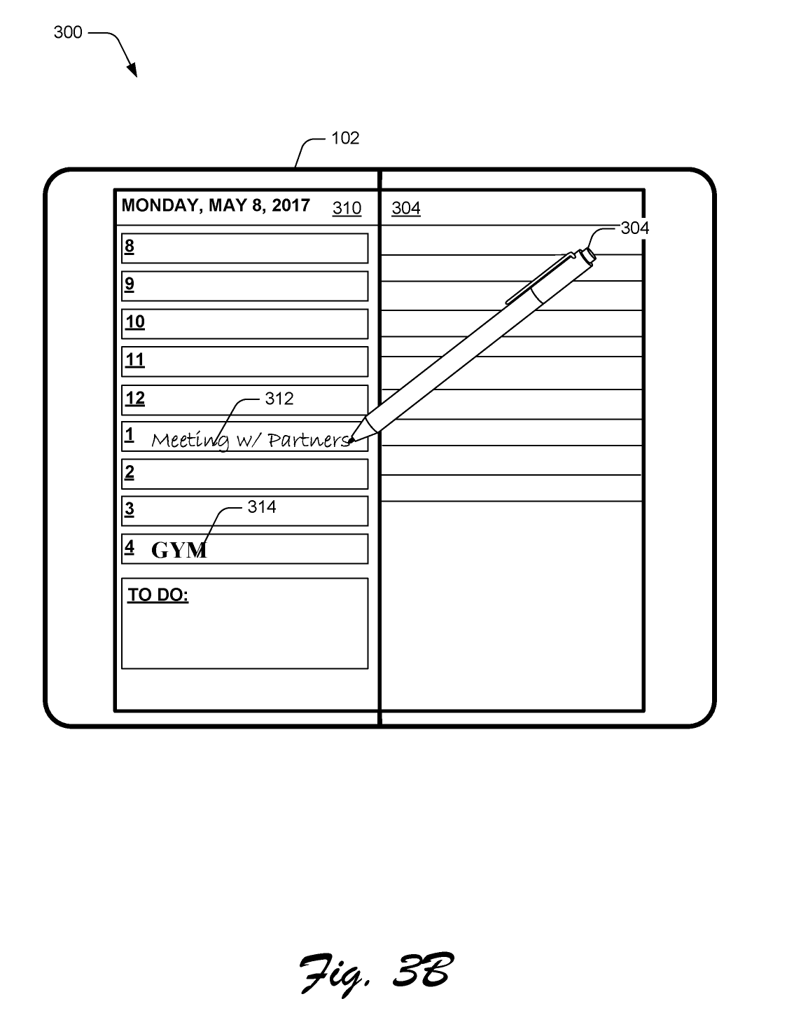

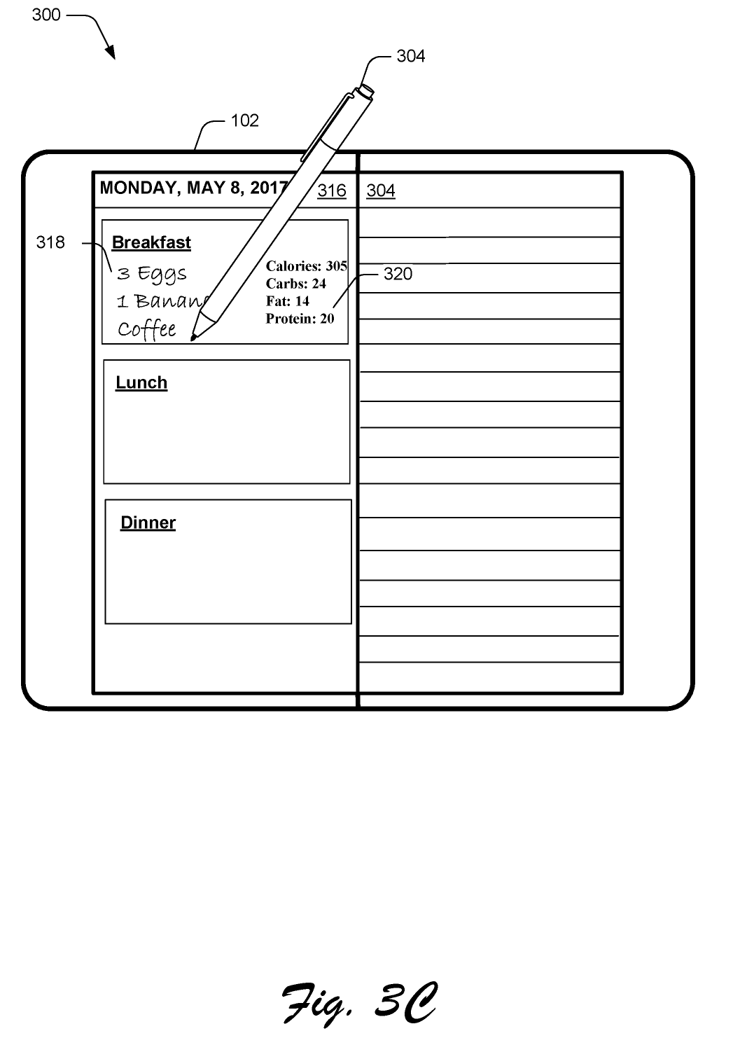

As an example, consider FIGS. 3A-3C, which illustrate various examples 300 of smart templates in accordance with one or more implementations.

In FIG. 3A client device 102 displays digital content as pages 302 and 304 of journal application 133 on display devices 104 and 106, respectively, of “dual-display” client device 102. However, as described throughout, in other cases the pages may be displayed on a “single-display” device and/or associated with a different type of application. As a default, the journal application 133 provides formless pages which enable the user to create by writing, drawing, inserting objects, and so forth. The journal application 133 is configured to receive free-form input to the pages via an input device, such as a stylus 306 or the user's finger.

In this example, a user interface 308 overlays journal page 302 and includes selectable representations associated with various smart templates. The selectable representations can be selected by the user in order to apply the corresponding smart template to one or more pages of the journal application. The smart templates, in this example, include a stock tracker smart template, a nutrition log smart template, and a planner smart template. Of course, a variety of other examples are also contemplated, such as a budget template, a shopping list, a to-do list, a calendar, and a training log, to name just a few.

In this example, the free-form user input is received via stylus 306 to select the selectable representation corresponding to the planner smart template using stylus 306. In response, smart page module 134 transforms the digital content of page 302. For example, in FIG. 3B the formless layout of page 302 has been changed to a smart page 310 by changing the layout of smart page 310 to a planner layout. Notably, the layout of smart page 310 has changed from resembling notebook paper to resembling a planner, which includes fields for different times of day, as well as a “to do” field. In this example, the smart template has not been applied to journal page 304 which remains as a blank, formless page. However, the user interface 308 may enable the user to select any number of pages to apply the smart template.

Returning to FIG. 2, smart page 208 receives user input 210, such as when the user writes or draws on the smart page using a stylus or the user's finger. In some cases, the smart page enables the user to write on the smart page in “free form”, such that any fields included in the smart page do not constrain the user input to a certain area. As such, the user can write on the smart page just as they would write on a paper journal. However, even though the user can write on the smart page in free form, the smart page module 134 is configured to process the user input 210 by applying various rules or functionalities associated with the smart page 208 in order to generate page data 212. In one or more implementations, the rules and functionalities of a smart page are based on the location of the smart page at which the user input is received. In other cases, the rules and functionalities may be based on the content of the user input itself without regard to the location at which the user input is received.

In one or more implementations, the smart page may be associated with one or more applications 214 that are configured to process and/or store the page data 212. For example, a calendar application may be associated with a planner smart page, a health application may be associated with a nutrition smart page, and so forth. The applications 214 may be installed locally at the client device 102 and/or remote from the client device 102 (e.g., as a cloud based service). Smart page module 134 is configured to communicate page data 212 to the application 214 associated with the smart page 208.

For example, in FIG. 3B, smart page 310 receives free-form user input and generates additional digital content 312 corresponding to the user input, when the user writes “Meeting w/Partners” on smart page 310 using stylus 306. Notably, the additional digital content 312 is received in a data field corresponding to 1 pm. In this example, smart page module 134 can determine, based on the rules of smart page 310 and the location at which the user input is received, that the user has an appointment at 1 pm on May 8, 2017 corresponding to a “Meeting with Partners”. Now, consider that smart page 310 is linked to a calendar application. In this case, when the user writes “Meeting with Partners”, the smart page module 134 generates appointment data and automatically synchronizes this appointment with the calendar application by updating the user's calendar to include the “Meeting with Partners” at 1 pm.

Returning to FIG. 2, in one or more implementations, the applications 214 associated with the smart page 208 can be configured to generate application data 216. In some cases, additional digital content corresponding to the application data is displayed on the smart page 208. In FIG. 3B, for example, additional digital content 314 corresponding to application data generated by the calendar application is displayed on the smart page, which in this instance corresponds to the user's 4 pm appointment for the “Gym”. Thus, digital content corresponding to this application data is displayed at the 4 pm time slot in the planner smart page in the journal application.

As another example, consider FIG. 3C, which illustrates a smart page 316 corresponding to a nutrition log. In this case, the smart page 316 is associated with a health application, which enables users to record what they eat. Smart page 316 receives free-form user input when the user writes “3 eggs, 1 Banana, and Coffee” on smart page 316 using stylus 306, and generates digital content 318 corresponding to the user input. Notably, the user input is received in a data field corresponding to “Breakfast”. Smart page module 134 determines, based on the rules and functionalities of smart page 316 and the location at which the free-form user input is received, that the user consumed 3 eggs, 1 banana, and coffee for breakfast this morning. Thus, in addition to recognizing the meaning of the free-form user input, smart page module 134 is also able to add context to the application data based on the location at which the user input is received. In other words, the user does not need to write the date or “breakfast” next to the user input. Next, smart page module 134 automatically communicates this information to the linked health application. The health application receives the application data and logs the data in the user's food log. The health application may also process the page data in a variety of different ways, such as by calculating the calories and macronutrients for each meal. In this example, the health application calculates the calories and macronutrients of the user's breakfast, and returns application data to the smart page 316 which is displayed as additional digital content 320 proximate the digital content 318 corresponding to the user input.

In some cases, the smart page module 134 enables the user to customize a page of the journal application with multiple different smart templates. For example, a user may wish to configure the journal such that each page is directed to a particular day, and includes separate smart template areas for a planner, food log, a workout log, and so forth.

The following discussion describes some example procedures in accordance with one or more implementations. The example procedures may be employed in the environment 100 of FIG. 1, the system 600 of FIG. 6, and/or any other suitable environment. The procedures, for instance, represent example procedures for implementation of the scenarios described above. In at least some implementations, the steps described for the various procedures can be implemented automatically and independent of user interaction.

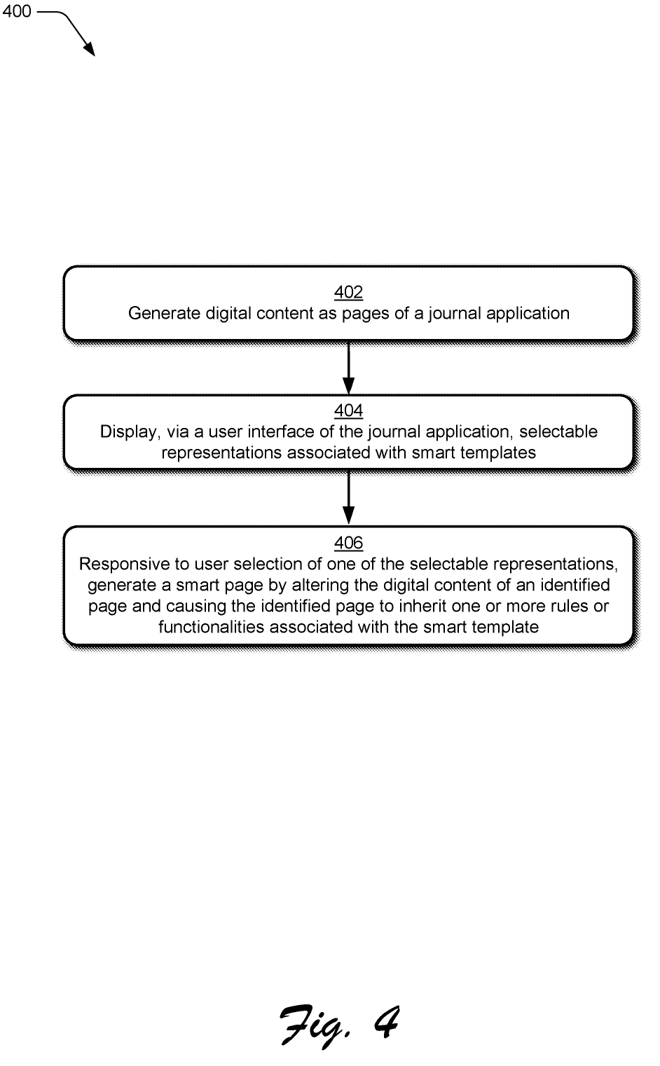

FIG. 4 is a flow diagram that describes steps in a method for applying smart templates to a journal application in accordance with one or more implementations.

At 402, digital content is generated as pages of a journal application. For example, digital content is generated as pages 204 of journal application 133.

At 404, selectable representations associated with smart templates are displayed via a user interface of the journal application. For example, selectable representations associated with smart templates 202 are displayed via a user interface 308 of the journal application.

At 406, responsive to user selection of one of the selectable representations, a smart page is generated by altering the digital content of an identified page and causing the identified page to inherit one or more rules or functionalities associated with the smart template. For example, responsive to user selection of one of the selectable representations, a smart page 208 is generated by altering the digital content of an identified page 204 and causing the identified page 204 to inherit one or more rules or functionalities associated with the smart template 202.

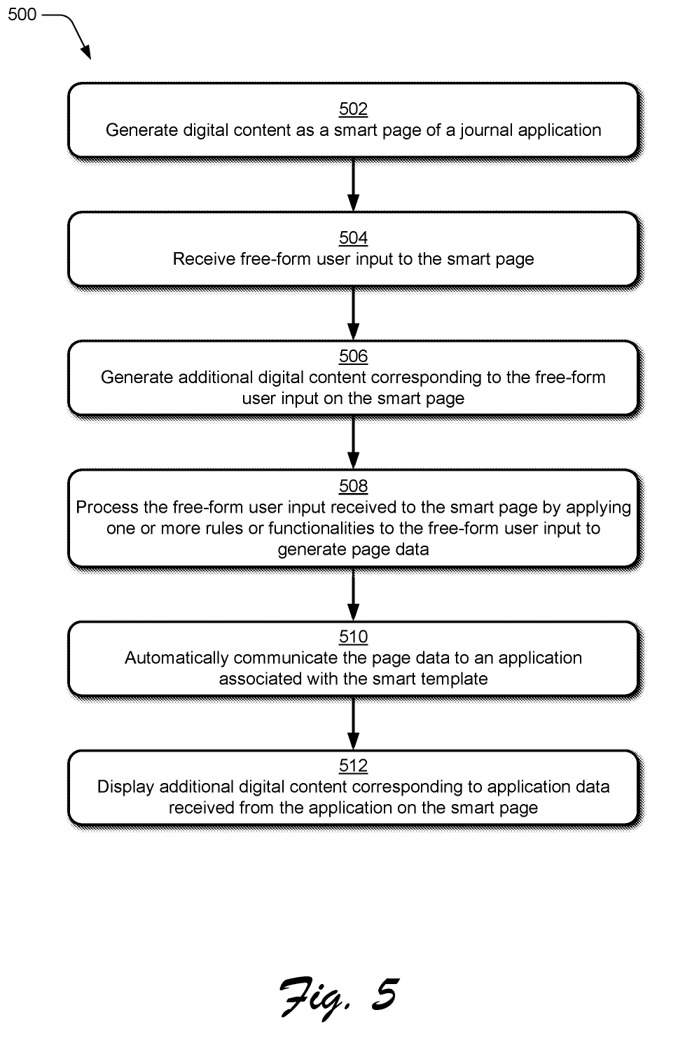

FIG. 5 is a flow diagram that describes steps in a method for generating page data based on user input received via a smart page in accordance with one or more implementations.

At 502, digital content is generated as a smart page of a journal application. For example, digital content is generated as smart page 208 of journal application 133.

At 504, free-form user input is received to the smart page. For example, free-form user input 210 is received to smart page 208, such as when a user writes on smart page 208 using a stylus.

At 506, additional digital content corresponding to the free-form user input is generated on the smart page. For example, additional digital content 312 corresponding to user input 210 is generated on smart page 208.

At 508, the free-form user input received to the smart page is processed by applying the one or more rules or functionalities to the free-form user input to generate page data. For example, smart page module 134 processes the user input 210 by applying the rules or functionalities associated with the smart template 202 in order to generate page data 212. In one or more implementations, the rules and functionalities of a smart page are based at least in part on a position in the smart page at which the user input is received. In other cases, the rules and functionalities may be based on the content of the user input itself without regard to the location at which the user input is received.

Optionally, at 510, the page data is automatically communicated to an application associated with the smart template. For example, smart page module 134 automatically communicates page data 212 to an application 214 associated with the smart template 202.

Optionally, at 512, additional digital content corresponding to application data received from the application is displayed on the smart page. For example, smart page module 134 display additional digital content corresponding to application data 216 generated by the application 214.

FIG. 6 illustrates an example system generally at 600 that includes an example computing device 602 that is representative of one or more computing systems and/or devices that may implement the various techniques described herein. In at least some implementations, the computing device 602 represents an implementation of the client device 102 discussed above. The computing device 602 may, for example, be configured to assume a mobile configuration through use of a housing formed and sized to be grasped and carried by one or more hands of a user, illustrated examples of which include a mobile phone, mobile game and music device, and tablet computer although other examples are also contemplated. In at least some implementations, the client device 102 may be implemented as a wearable device, such as a smart watch, smart glasses, a dual-surface gesture-input peripheral for a computing device, and so forth.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media and does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

Example implementations described herein include, but are not limited to, one or any combinations of one or more of the following examples:

In one or more examples, a computing device comprises: one or more display devices; at least one processor; and at least one computer-readable storage media storing instructions that are executable by the at least one processor to implement a journal application, the journal application configured to: generate digital content as pages of the journal application, and display the pages on the one or more display devices; display, via a user interface of the journal application, selectable representations associated with smart templates; and responsive to user selection of one of the selectable representations, generate a smart page by both altering the digital content of an identified page of the journal application and causing the identified page to inherit one or more rules or functionalities associated with the smart template.

An example as described alone or in combination with any of the other examples described above or below, wherein the journal application is configured to alter the digital content of the identified page by changing a visual layout of the identified page.

An example as described alone or in combination with any of the other examples described above or below, wherein the journal application is further configured to: receive free-form user input to the smart page; generate additional digital content corresponding to the free-form user input on the smart page; and process the free-form user input received to the smart page by applying the one or more rules or functionalities to the free-form user input to generate page data.

An example as described alone or in combination with any of the other examples described above or below, wherein the journal application is further configured to communicate the page data to an application associated with the smart template.

An example as described alone or in combination with any of the other examples described above or below, wherein the communication of the page data to the application causes a synchronization of the page data with the application.

An example as described alone or in combination with any of the other examples described above or below, wherein the journal application is further configured to display additional digital content on the smart page corresponding to application data received from the application.

An example as described alone or in combination with any of the other examples described above or below, wherein the application data is generated by the application based at least in part on the page data.

An example as described alone or in combination with any of the other examples described above or below, wherein the journal application is configured to apply one or more rules or functionalities of the smart page to the free-form user input based at least in part on a position in the smart page at which the user input is received.

An example as described alone or in combination with any of the other examples described above or below, wherein the computing device comprises a dual-display device comprising a first display device and a second display device.

An example as described alone or in combination with any of the other examples described above or below, wherein digital content is displayed as a sequence of pages of the journal application on both the first and second display devices of the dual-display device.

An example as described alone or in combination with any of the other examples described above or below, wherein the user input is received as touch input to the first or second display devices via a stylus or a finger of a user.

In one or more examples, a method for applying smart templates to a journal application of at least one computing device comprises: generating digital content as pages of the journal application; displaying, via a user interface of the journal application, selectable representations associated with smart templates; responsive to user selection of one of the selectable representations, generating a smart page by altering the digital content of an identified page and causing the identified page to inherit one or more rules or functionalities associated with the smart template; receiving free-form user input to the smart page; generating additional digital content corresponding to the free-form user input on the smart page; and processing the free-form user input received to the smart page by applying the one or more rules or functionalities to the free-form user input to generate page data.

An example as described alone or in combination with any of the other examples described above or below, further comprising automatically communicating the page data to an application associated with the smart template.

The method of claim 13, wherein the automatically communicating the page data causes a synchronization of the page data with the application.

An example as described alone or in combination with any of the other examples described above or below, further comprising displaying additional digital content on the smart page corresponding to application data received from the application.

An example as described alone or in combination with any of the other examples described above or below, wherein the application data is generated by the application based at least in part on the page data.

An example as described alone or in combination with any of the other examples described above or below, wherein the generating the smart page comprises altering the digital content of the identified page by changing a visual layout of the identified page.

An example as described alone or in combination with any of the other examples described above or below, wherein the one or more rules or functionalities of the smart page which are applied to the user input are based at least in part on a position in the smart page at which the user input is received.

In one or more examples, one or more computer-readable storage devices comprises instructions stored thereon that, responsive to execution by one or more processors, perform operations comprising: generating digital content as pages of a journal application; displaying, via a user interface of the journal application, selectable representations associated with smart templates; responsive to user selection of one of the selectable representations, generating a smart page by altering the digital content of an identified page and causing the identified page to inherit one or more rules or functionalities associated with the smart template; receiving free-form user input to the smart page; generating additional digital content corresponding to the free-form user input on the smart page; and processing the free-form user input received to the smart page by applying the one or more rules or functionalities to the free-form user input to generate page data.

An example as described alone or in combination with any of the other examples described above or below, further comprising instructions that, responsive to execution by the one or more processors, perform operations comprising communicating the page data to an application associated with the smart template to cause a synchronization of the page data with the application.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device comprising:
one or more display devices;
at least one processor; and
at least one computer-readable storage media storing instructions that are executable by the at least one processor to implement a journal application, the journal application configured to:
generate digital content as pages of the journal application, and display the pages on the one or more display devices;
display, via a user interface of the journal application, selectable representations associated with smart templates; and
responsive to user selection of one of the selectable representations, generate a smart page by both altering the digital content of an identified page of the journal application and causing the identified page to inherit one or more rules or functionalities associated with the smart template.

2. The computing device of claim 1, wherein the journal application is configured to alter the digital content of the identified page by changing a visual layout of the identified page.

3. The computing device of claim 1, wherein the journal application is further configured to:
receive free-form user input to the smart page;
generate additional digital content corresponding to the free-form user input on the smart page; and
process the free-form user input received to the smart page by applying the one or more rules or functionalities to the free-form user input to generate page data.

4. The computing device of claim 3, wherein the journal application is further configured to communicate the page data to an application associated with the smart template.

5. The computing device of claim 4, wherein the communication of the page data to the application causes a synchronization of the page data with the application.

6. The computing device of claim 4, wherein the journal application is further configured to display additional digital content on the smart page corresponding to application data received from the application.

7. The computing device of claim 6, wherein the application data is generated by the application based at least in part on the page data.

8. The computing device of claim 3, wherein the journal application is configured to apply one or more rules or functionalities of the smart page to the free-form user input based at least in part on a position in the smart page at which the user input is received.

9. The computing device of claim 3, wherein the free-form user input is received as touch input to the one or more display devices via a stylus or a finger of a user.

10. The computing device of claim 1, wherein the computing device comprises a dual-display device comprising a first display device and a second display device.

11. The computing device of claim 10, wherein digital content is displayed as a sequence of pages of the journal application on both the first and second display devices of the dual-display device.

12. A method for applying smart templates to a journal application of at least one computing device, the method comprising:
generating digital content as pages of the journal application;
displaying, via a user interface of the journal application, selectable representations associated with smart templates;
responsive to user selection of one of the selectable representations, generating a smart page by altering the digital content of an identified page and causing the identified page to inherit one or more rules or functionalities associated with the smart template;
receiving free-form user input to the smart page;
generating additional digital content corresponding to the free-form user input on the smart page; and
processing the free-form user input received to the smart page by applying the one or more rules or functionalities to the free-form user input to generate page data.

13. The method of claim 12, further comprising automatically communicating the page data to an application associated with the smart template.

14. The method of claim 13, wherein the automatically communicating the page data causes a synchronization of the page data with the application.

15. The method of claim 13, further comprising displaying additional digital content on the smart page corresponding to application data received from the application.

16. The method of claim 15, wherein the application data is generated by the application based at least in part on the page data.

17. The method of claim 12, wherein the generating the smart page comprises altering the digital content of the identified page by changing a visual layout of the identified page.

18. The method of claim 12, wherein the one or more rules or functionalities of the smart page which are applied to the user input are based at least in part on a position in the smart page at which the user input is received.

19. One or more computer-readable storage devices comprising instructions stored thereon that, responsive to execution by one or more processors, perform operations comprising:
generating digital content as pages of a journal application;
displaying, via a user interface of the journal application, selectable representations associated with smart templates;
responsive to user selection of one of the selectable representations, generating a smart page by altering the digital content of an identified page and causing the identified page to inherit one or more rules or functionalities associated with the smart template;
receiving free-form user input to the smart page;
generating additional digital content corresponding to the free-form user input on the smart page; and
processing the free-form user input received to the smart page by applying the one or more rules or functionalities to the free-form user input to generate page data.

20. The one or more computer-readable storage devices of claim 19, further comprising instructions that, responsive to execution by the one or more processors, perform operations comprising communicating the page data to an application associated with the smart template to cause a synchronization of the page data with the application.
